(19) United States
(12) Patent Application Publication
(10) Pub. No.: US 2021/0355294 A1
(43) Pub. Date: Nov. 18, 2021

(54) HIGH GLOSS, ABRASION RESISTANT THERMOPLASTIC ARTICLE

(71) Applicant: Arkema Inc., King of Prussia, PA (US)

(72) Inventors: Charles C. CRABB, Royersford, PA (US); Robert J. BARSOTTI, Newtown Square, PA (US); Joseph L. MITCHELL, Boyertown, PA (US); Samuel SCHULTE, Spring City, PA (US); Brian M. CROMER, Wayne, PA (US); Jing-Han WANG, King of Prussia, PA (US)

(21) Appl. No.: 16/960,408

(22) PCT Filed: Jan. 16, 2018
(86) PCT No.: PCT/US18/13826

§ 371 Date: Jul. 7, 2020

Related U.S. Application Data
(60) Provisional application No. 62/446,602, filed on Jan. 16, 2017.
(60) Provisional application No. 62/549,622, filed on Aug. 24, 2017.

(51) Int. Cl. C08K 3/04; C08K 3/36; C08K 3/22; C08K 7/26; C08J 3/205; B32B 27/30; B32B 27/20; B32B 27/08

(52) U.S. Cl. CPC C08K 3/04; B29C 48/022; C08K 3/22; C08K 7/26; C08J 3/2056; B32B 27/302; B32B 27/308; B32B 27/20; B32B 27/08; C08K 2201/014; C08K 2201/005; C08K 2201/011; C08K 2003/2296; B32B 2264/1021; B32B 2307/406; B32B 2307/584; C08K 3/36

(57) ABSTRACT

The invention relates to a thermoplastic composition used for forming articles having both high gloss and excellent resistance to mar, scratch and/or abrasion. The composition contains very high levels of nano-sized inorganic additives, such as alumina, silica and titanium dioxide. Acrylic polymer compositions, such as Arkema's PLEXIGLAS® resins, with 5 to 25 weight percent of sized fumed silica are a preferred embodiment of the invention, especially when combined with a dye or pigment.

### FIELD OF THE INVENTION

The invention relates to a thermoplastic composition useful for forming articles having both high gloss and excellent resistance to mar, scratch and/or abrasion. The composition contains very high levels of nano-sized inorganic fillers, such as alumina, silica and titanium dioxide. Acrylic polymer compositions with 5 to 25 weight percent of sized fumed silica are a preferred embodiment of the invention, especially when combined with a dye or pigment.

### BACKGROUND OF THE INVENTION

Thermoplastic articles exposed to the environment experience mar and scratch damage due to contact with objects, both large and small. It is often desired to protect the thermoplastic from such damage.

Additives are often blended into a thermoplastic to provide improvement in one or more properties, including protection from damage. Impact modifiers are used to dampen the effect of the impact from a strike by an object. Mineral additives, such as silica are mentioned in the art in combination with polymethyl methacrylate (PMMA) in order to improve thermal properties, abrasion resistance and strength. A problem with mineral fillers, is that they are effective matting agents, which reduce the gloss of a thermoplastic. Nano-sized fillers typically have low bulk density, making them difficult to disperse into a thermoplastic. This is particularly a problem in polar thermoplastics because mineral fillers tend to agglomerate in a polar thermoplastic composition. The very low levels of the minerals that can be dispersed into the thermoplastic provide little or no abrasion or mar resistance.

A high gloss, mar resistant thermoplastic is desired. Currently, mar resistance and high gloss are provided for a thermoplastic, such as polycarbonate, using a cross-linkable hard coating on top of the thermoplastic. Hard-coat systems are effective at mar resistance, and provide a high gloss finish—however they are expensive, and increase the complexity of the production process, as they require an additional application step, as well as a curing step.

There is a need for an easier and less expensive solution to provide a high gloss, mar resistant thermoplastic in industries such as the automotive industry, building and construction industry, and for enclosures on electronics like smart phones, and computers.

After extensive research, it has surprisingly been found that very high loadings of nano-sized inorganic fillers can be well dispersed into a thermoplastic composition, and the result is a composition that forms a high gloss, highly mar resistant thermoplastic article. Further, when high loadings of silica, plus other additives such as pigments are combined in a thermoplastic composition, a synergy provides both a high mar resistance and a high scratch resistance in a high gloss article. Utilization of certain nano-sized inorganic fillers in thermoplastics is also found to improve scratch resistance tremendously.

### SUMMARY OF THE INVENTION

The invention relates to a composition comprising

a) one or more thermoplastics,

b) greater than 1 weight percent, preferably greater than 3 weight percent, more preferably greater than 5 weight percent, more preferably greater than 8 weight percent, more preferably greater than 10 weight percent, and more preferably greater than 15 weight percent of nano-sized inorganic filler, based on the weight of the thermoplastic, and having a number average particle size of less than 500 nm, preferably less than 300 nm, more preferably less than 100 nm, and more preferably less than 50 nm,

c) from 0.05 to 20 weight percent of dye and/or pigment, preferably 0.1 to 3 weight percent, more preferably 0.7 to 2 weight percent, based on the weight of the thermoplastic.

The invention further relates to a process for forming a high-gloss, mar-resistant article comprising the steps of adding a nano-sized inorganic filler to the thermoplastic via melt compounding, wherein said nano-sized inorganic filler is added at levels of less greater than 0.1 weight percent, preferably greater than 2 weight percent, preferably a greater than five weight percent, more preferably greater than 10 weight percent, and most preferably at greater than 15 weight percent.

The invention further relates to a multi-layer structure, wherein said outermost layer, is made of the composition of the invention. And further articles made with the composition of the invention. All articles and processes involve a thermoplastic polymer blended with nano-sized inorganic fillers.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Aspects of the invention include:
1. A composition comprising

a) one or more thermoplastics

b) greater than 1 weight percent, preferably greater than 3 weight percent, more preferably greater than 5 weight percent, more preferably greater than 8 weight percent, more preferably greater than 10 weight percent, and more preferably greater than 15 weight percent of one or more nano-sized inorganic filler, based on the weight of the thermoplastic, and having a number average particle size of less than 500 nm, preferably less than 300 nm, more preferably less than 100 nm, and more preferably less than 50 nm,

c) from 0.05 to 20 weight percent of dye and/or pigment, preferably 0.1 to 20 weight percent, more preferably 0.7 to 5 weight percent, based on the weight of the thermoplastic.
2. The composition of aspect 1, wherein said dye or pigment comprises a carbonaceous material.
3. The composition of aspects 1 or 2, wherein said carbonaceous material is a nano carbon, having a number average particle size of less than 500 nm, preferably less than 300 nm, more preferably less than 100 nm, and more preferably less than 50 nm.
4. The composition of aspects 2 or 3, wherein said carbonaceous material is selected from the group consisting of nano-graphite, thermally reduced graphite oxide, graphite flakes, expanded graphite, graphite nano-platelets, graphene, single-walled carbon nanotubes, multi-walleyed carbon nanotubes, multi-layered graphenes.
5. The composition of any or aspects 1 to 4, wherein said nano-sized inorganic filler is a silica compound.
6. The composition of aspect 5, wherein said silica compound is selected from the group consisting of fumed silica, precipitated silica, silica fume, or silicas produced by sol-gel processes.
7. The composition of any or aspects 1 to 6, wherein said thermoplastic is selected from the group consisting of acrylic polymers, styrenic polymers, polyolefins, polyvinyl chloride (PVC), polycarbonate (PC), polyurethane (PU), thermoplastic fluoropolymers or mixtures thereof.
8. The composition of aspect 7, wherein said thermoplastic is an acrylic polymer.
9. The composition of aspect 8, wherein said acrylic polymer is an acrylic copolymer containing (meth)acrylic acid monomer units.
10. The composition of aspect 8 or 9, wherein said acrylic polymer has a Melt Flow Rate of >3 when measured by ASTM D1238 with 230° C., 3.8 kg.
11. The composition of aspect 1 wherein a plaque formed by injection molding has superior mar resistance as measured by an increase in 60° gloss or a decrease in 60° gloss of <20 units, preferably less than 15 units, more preferably less than 10 units and most preferably less than 5 units, after 250 cycles in a Crock Meter Mar test using a 2 micron aluminum oxide cloth abrading material, as compared to a composition without the nano-sized inorganic filler which would experience a 60° gloss loss of >20 units in a similar test.
12. The composition of any or aspects 1 to 11, where an injected molded plaque formed from said composition has a gloss that is within 30%, preferably 20%, more preferably 10%, and most preferably 5%, of an injection molded plaque of similar composition but without the nano-sized inorganic filler measured by BYK gloss meter.
13. The composition of any or aspects 1 to 12, where an injected molded plaque formed from said composition has a Delta E Color Value that is <20 units, more preferably less than 10 units, more preferably less than 5, and most preferably less than 2.5) as compared to the color an injection molded plaque of similar composition but without the nano-sized inorganic filler measured by CIE L*a*b* on X-Rite Color 17 spectrophotometer.
14. The composition of any or aspects 2 to 12, wherein said composition comprises 0.01 to 5 weight percent of nanographite and 1 to 25 weight percent of silica, wherein an injection molded plaque heat formed from said composition has superior scratch resistance as compared to an injection molded plaque of similar composition but without the nanocarbon as measured by a 10% (preferably 20%, 30%, 40%, 50%) decrease in scratch width when tested in a 4 finger test with load of >3N of force and a superior mar resistance, as measured as either an increase in 60° gloss or a decrease in 60° gloss of <20 units, preferably 15 units, more preferably 10 units, and most preferably 5 units after 250 cycles in a Crock Meter Mar test using a 2 micron aluminum oxide cloth abrading material, as compared to a similar composition without the nano-sized inorganic filler which would experience a 60° gloss loss of >20 units in a similar test.
15. The composition according to any or aspects 1 to 14 wherein said nano-sized inorganic filler comprises a surface treatment, and wherein said surface-treated nano-sized inorganic filler is selected such that a PMMA plaque formed using 20 weight percent loading surface-treated nano-sized inorganic filler has a MFI decrease of less than 30%, more preferably less than 25%, more preferably less than 20%, most preferably less than 10%, compared to a similar plaques comprising 20 weight percent of an un-modified silica.
16. A composition comprising:

a) an acrylic polymer having a weight average molecular weight of greater than 500,000;

b) greater than 1 weight percent, preferably greater than 3 weight percent, more preferably greater than 5 weight percent, more preferably greater than 8 weight percent, more preferably greater than 10 weight percent, and more preferably greater than 15 weight percent of one or more nano-sized inorganic filler, based on the weight of the thermoplastic, and having a number average particle size of less than 500 nm, preferably less than 300 nm, more preferably less than 100 nm, and more preferably less than 50 nm.
17. The composition of aspect 16, wherein said composition further comprises from 0.05 to 20 weight percent of dye and/or pigment, preferably 0.1 to 20 weight percent, more preferably 0.7 to 5 weight percent, based on the weight of the acrylic polymer.
18. The composition of aspects 16 or 17, wherein said composition is formed by a cell cast process.
19. A process for increasing mar resistance without loss of gloss in a melt process thermoplastic article comprising the steps of adding a nano-sized inorganic filler to the thermoplastic via melt compounding, wherein said nano-sized inorganic filler is added at levels of less greater than 0.1 weight percent, preferably greater than 2 weight percent, preferably a greater than five weight percent, more preferably greater than 10 weight percent, and most preferably at greater than 15 weight percent.
20. The process of aspect 19, wherein said inorganic filler is added directly to the thermoplastic melt via one or more side stuffers placed downstream on the extrusion barrel from the main feeder where thermoplastic resin is added.
21. The process of aspect 19 or 20 wherein a densifying screw feeder or crammer feeder is incorporated into the side stuffer.
22. The process of any or aspects 19 to 21 wherein said inorganic filler is preheated prior to being added to the thermoplastic in the melt compounding step.
23. The process of any or aspects 19 to 22 wherein a liquid is added to the inorganic additive prior to addition to the molten thermoplastic stream.
24. The process of any or aspects 19 to 23, comprising multiple iterations of pulverization and melt extrusion, to achieve very high loadings of silica by adding up to 5 weight percent or more inorganic filler on each pass.
25. A process for forming a homogeneous blend composition of a thermoplastic and a nano-sized inorganic filler, comprising the step of mixing said nano-sized inorganic filler with one or more (meth)acrylic monomer(s), or a mixture of (meth)acrylic monomer(s), and thermoplastic polymer, followed by polymerization of the (meth)acrylic monomer.
26. The process of aspect 25 wherein said (meth)acrylic monomer/nano-sized inorganic oxide mixture is polymerized in a continuous mass reactor followed by devolatization and extrusion.
27. The process of aspects 25 or 26, wherein said (meth)acrylic monomer(s)/nano-sized inorganic filler dispersion is polymerized inside of a one or two sided mold, with suitable initiators and additives, and optionally wet-out fibers or fillers.
28. A multi-layer structure, wherein said outermost layer, in contact with the environment, comprises a thermoplastic matrix having dispersed therein greater than 1 weight percent, preferably greater than 3 weight percent, more preferably greater than 5 weight percent, more preferably greater than 8 weight percent, more preferably greater than 10 weight percent, and more preferably greater than 15 weight percent of nano-sized inorganic filler, based on the weight of the thermoplastic, and wherein said nano-size inorganic filler has a number average particle size of less than 500 nm, preferably less than 300 nm, more preferably less than 100 nm, and more preferably less than 50 nm.
29. The multi-layer structure of aspect 28, wherein said multilayer structure is formed by coextrusion, co-injection molding, two shot injection molding, insert molding, extrusion lamination, compression molding
30. The multi-layer structure of aspects 28 or 29, comprising an outer layer and an inner layer, wherein the outer layer has a thickness of from 0.1 to 10 mm, and said inner layer has a thickness of from 0.1 to 250 mm.
31. The multi-layer structure of any of aspects 28 to 30, wherein at least one of the layers further comprises from 0.05 to 25 weight percent of additives selected from the group consisting of dyes, pigment metallic flakes, matting agents and granite-look cross-linked polymer particles preferably 0.1 to 20 weight percent, more preferably 0.7 to 5 weight percent, based on the weight of the thermoplastic.
32. The multi-layer structure of any of aspects 28 to 31, wherein said structure is a cover for a light source.

### DETAILED DESCRIPTION OF THE INVENTION

The invention relates to a high-gloss, mar resistant composition containing a high loading of nano-silica, preferably in combination with a dye or pigment.

All percentages used herein are weight percentages unless stated otherwise, and all molecular weights are weight average molecular weights determined by gel permeation chromatography unless stated otherwise. All references listed are incorporated herein by reference.

The invention will be generally described, and will also include a silica/acrylic polymer system as a model system. One of ordinary skill in the art will recognize, based on the following description and examples, that other thermoplastics and other nano-sized inorganic fillers may be used with comparable results.

### Matrix Polymer:

The thermoplastic used as the matrix polymer in the compositions of the invention can be any highly weatherable thermoplastic. Particularly preferred thermoplastics include, but are not limited to acrylic polymers, styrenic polymers, polyolefins, polyethylene terephthalate (PET), polybutylene terephthalate (PBT), polyvinyl chloride (PVC), polycarbonate (PC), polyurethane (PU), thermoplastic fluoropolymers, or mixtures thereof.

Styrenic polymers, as used herein, include but are not limited to, polystyrene, high-impact polystyrene (HIPS), acrylonitrile-butadiene-styrene (ABS) copolymers, acrylonitrile-styrene-acrylate (ASA) copolymers, styrene acrylonitrile (SAN) copolymers, methacrylate-acrylonitrile-butadiene-styrene (MABS) copolymers, styrene-butadiene copolymers (SB), styrene-butadiene-styrene block (SBS) copolymers and their partially or fully hydrogenenated derivatives, styrene-isoprene copolymers styrene-isoprene-styrene (SIS) block copolymers and their partially or fully hydrogenenated derivatives, styrene-(meth)acrylate copolymers such as styrene-methyl methacrylate copolymers (S/MMA), and mixtures thereof. A preferred styrenic polymer is ASA.

Acrylic polymers, as used herein, include but are not limited to, homopolymers, copolymers and terpolymers comprising alkyl methacrylates. The alkyl methacrylate monomer is preferably methyl methacrylate, which may make up from 51 to 100 of the monomer mixture, preferably greater than 60 weight percent, more preferably greater than 75 weight percent, and most preferably greater than 85 weight percent. The remaining monomers used to form the polymer are chosen from other acrylate, methacrylate, and/or other vinyl monomers may also be present in the monomer mixture. Other methacrylate, acrylate, and other vinyl monomers useful in the monomer mixture include, but are not limited to methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers, styrene and its derivatives. Alkyl (meth) acrylic acids such as (meth)acrylic acid and acrylic acid can be useful for the monomer mixture. Small levels of multifunctional monomers as crosslinking agents may also be used. A preferred acrylic polymer is a copolymer of methyl methacrylate and 2-16 percent of one or more C₁₋₄ acrylates.

The thermoplastic polymers of the invention can be manufactured by any means known in the art, including emulsion polymerization, bulk polymerization, solution polymerization, and suspension polymerization. In one embodiment, the thermoplastic matrix has a weight average molecular weight of between 50,000 and 5,000,000 g/mol, and preferably from 75,000 and 150,000 g/mol, as measured by gel permeation chromatography (GPC). The molecular weight distribution of the thermoplastic matrix may be monomodal, or multimodal with a polydispersity index greater than 1.5.

In one embodiment the acrylic polymer has a low viscosity, as shown by a Melt Flow Rate of >3 when measured by ASTM D1238 with 230° C., 3.8 kg. The low viscosity acrylic polymer could be achieved by means known in the art, such as by the proper selection of comonomer(s), inclusion of low molecular weight acrylic polymers—including multi-modal molecular weight distributions with low molecular weight modes and higher molecular weight modes, or a very broad molecular weight distribution. It was found that low viscosity (low melt flow) acrylic polymers allow for faster and higher loading of silica into the compounded composition.

In another embodiment, the thermoplastic matrix has a weight average molecular weight greater >500,000 g/mol—as can be achieved in a cell cast acrylic process.

### Nano-Sized Inorganic Filler

The composition of the invention includes at least one nano-sized inorganic filler. Useful nano-sized inorganic fillers include, but are not limited to silica, alumina, zinc oxide, barium oxide, molybdenum disulfide, boron nitride, tungsten disulfide, and titanium oxide.

The nano-sized inorganic fillers of the invention have a primary number average particle size of less than 500 nm, preferably less than 300 nm, more preferably less than 100 nm, and most preferably less than 50 nm. Smaller average size particles are better, as they provide less light scattering, and therefore produce a glossier surface. The nano-size is the size of the primary particle. Particles may agglomerate and the agglomerates containing many particles may have a number average agglomerate particle size of greater than a micron, greater than 5 microns, greater than 10 microns and even up to 40 microns in number average agglomerate particle size.

Nano-silica is especially preferred. Examples of useful nano-silica materials include, but are not limited to, fumed silica, precipitated silica, silica fume, or silicas produced by sol-gel processes. The nano-silica may be treated through surface treatment processes known to those skilled in the art. Nano-silica treated with a surface treatment is referred to as “surface-modified nano-silica.” Surface treatment compounds, referred to as “surface modifiers,” may include but are not limited to diethyldichlorosilane, allylmethyldichlorosilane, methylphenyldichlorosilane, phenylethyldichlorosilane, octadecyldimethylchlorosilane, dimethyldichlorosilane, butyldimethylchlorosilane, hexamethylenedisilazane, trimethylchlorosilane, .octyldimethylchlorosilane, or a reactive group terminated organopolysiloxane. The surface treatment may improve the dispersion of the nano-mineral oxide in the matrix polymer and may also improve the rheological properties of the matrix polymer.

Nano-zinc oxide is also especially preferred. The nano-zinc oxide at high loading does not need to be surface modified for good dispersion, though a surface treatment compatible with the thermoplastic polymer may be used.

The level of nano-sized inorganic filler in the composition is greater than 1 wt percent, greater than 2 weight percent, preferably greater than 3 weight percent, preferably greater than 5 weight percent, more preferably greater than 8 weight percent, more preferably greater than 10 weight percent, more preferably greater than 15 weight percent, and most preferably 20 weight percent or higher, based on the total weight of the thermoplastic composition. Levels of greater than 5 to 25 weight percent are especially preferred, which higher level providing increased mar resistance, with little change in gloss.

In one embodiment, it is preferred if at least some silica migrate to achieve a higher concentration at the interface of a formed article. This will improve the mar resistance. One means of accomplishing this is to anneal the product at a temperature just below the melting point (crystalline polymers) or glass transition point of the matrix polymer for a period of time, in order to enhance the gloss and mar resistance by move to the surface of an article. Slow cooling of an article formed by a heat process could also provide a surface with a higher concentration of silica than the interior of the article.

It is also within the scope of the invention to chemically modify the surface energy of the nano-sized inorganic filler by the use of surface modifiers, corona treatment or other surface modification, to influence the migration of the nano-particles toward a surface or interface. Alternatively, one could modify the surface energy of the thermoplastic matrix to influence the nano-sized inorganic filler migration toward a surface or interface. The thermoplastic could be modified by known means, such as the choice of comonomers, of a post-polymerization grafting or functionalization.

### Pigment or Dye

In a preferred embodiment, a pigment or dye is added to the thermoplastic/nano-sized inorganic filler composition. It is possible to use the thermoplastic/nano-sized inorganic filler composition without dye, to provide good mar resistance. A clear, colorless composition would be especially useful as a cap layer on top of a pigmented layer in a multi-layer structure.

The level of pigment or dye in the composition is preferably from 0.2 to 25 weight percent, preferably 0.5 to 20 weight percent, and most preferably from 1 to 5 weight percent, based on the total composition. The addition of the dye or pigment can produce a clear article (having a haze level of less than 10 percent, and preferably less than 3 percent; a translucent article having a haze level of from 10 to 35 percent, preferably from 15 to 25 percent; or an opaque article.

Useful dyes and pigments of the invention include, but are not limited to: Cadmium zinc sulphide, CI Pigment Yellow 35, (CAS Reg. No. 8048-07-5, Reach No. 01-2119981639-18-0001), Cadmium sulphoselenide orange, CI Pigment Orange 20, (CAS Reg. No. 12656-57-4, Reach No. 01-2119981636-24-0001), Cadmium sulphoselenide red (CI Pigment Red 108, CAS Reg. No. 58339-34-7, Reach No. 01-2119981636-24-0001), Carbon Black (PBlk-7), TiO2 (PW-6), BaSO4 (PW-21 and PW-22), CaCO3 (PW-18), PbCO3, Pb(OH)2, (PW1), MACROLEX® Yellow 6G, MACROLEX® Yellow 3G, MACROLEX® Yellow G, MACROLEX® Yellow E2R, MACROLEX® Yellow RN, MACROLEX® Orange 3G, MACROLEX® OrangeR, MACROLEX® Red E2G, MACROLEX® Red A MACROLEX® Red EG, MACROLEX® Red G, MACROLEX® Red H, MACROLEX® RedB, MACROLEX® Red 5B, MACROLEX® Red Violet, MACROLEX®Violet 3R, MACROLEX® Violet B, MACROLEX® Violet 3B, MACROLEX® Blue 3R, MACROLEX® Blue RR, MACROLEX® Blue 2B, MACROLEX® Green 5B, MACROLEX® Green G, MACROLEX® FluorescentYel., and MACROLEX®.

One very useful pigment, when used with and without any nano-sized inorganic filler, is a nano-carbonaceous material. Nano-carbon was found to provide scratch resistance to the thermoplastic, but appears to have little effect on the gloss. Useful carbonaceous compounds are nano carbons having a number average particle size of less than 500 nm, preferably less than 300 nm, more preferably less than 100 nm, and more preferably less than 50 nm. Carbon of larger size has poor dispersion in the thermoplastic. Carbonaceous materials useful in the invention include, but are not limited to nano-graphite, thermally reduced graphite oxide, graphite flakes, expanded graphite, graphite nano-platelets, graphene, single-walled carbon nanotubes, multi-walled carbon nanotubes.

The synergistic combination of both a high loading of silica, plus nano-carbon was found to produce an article having high gloss, excellent mar resistance, and excellent scratch resistance.

### Other Additives:

The composition may optionally contain one or more typical additives for polymer compositions used in usual effective amounts, including but not limited to impact modifiers (both core-shell and linear block copolymers), stabilizers, plasticizers, fillers, coloring agents, pigments, antioxidants, antistatic agents, surfactants, toner, refractive index matching additives, additives with specific light diffraction, light absorbing, or light reflection characteristics, dispersing aids, radiation stabilizers such as poly(ethylene glycol), poly(propylene glycol), butyl lactate, and carboxylic acids such as lactic acid, oxalic acid, and acetic acid, light modification additives, such as polymeric or inorganic spherical particles with a particle size between 0.5 microns and 1,000 microns. The amount of additives included in the polymer composition may vary from about 0% to about 70% of the combined weight of polymer, inorganic mineral oxide, and additives. Generally amounts from about 0.5% to about 45%, preferably from about 5% to about 40%, are included. The additives can be added into the composition prior to being added to the extruder, or may be added into the molten composition part way through the extruder.

In one embodiment, impact modifiers are added at from 3 to 70 weight percent, based on the weight of the formulation, and preferably from 10 to 50 weight percent. The addition of the silica to a PMMA tends to decrease impact resistance, and therefore the addition of impact modifiers can counter that decrease.

### Processing

The thermoplastic and nano-sized inorganic filler may be combined in several different ways, to provide a well-dispersed, high level of nano-sized inorganic filler in the composition. The process involves a melt-processing step. The key is to obtain good dispersion of a high level of the nano-sized inorganic filler.

In one embodiment, a thermoplastic powder is dry blended with the nano-sized inorganic filler prior to adding to an extruder, or other heat processing equipment. It has been found that it is sometimes difficult to effectively disperse more than about 5 weight percent of nano-sized inorganic filler into a PMMA polymer at one time. So to get higher levels of nano-sized inorganic filler, the dry blend is extruded, pelletized and finely ground. The nano-sized inorganic filler/PMMA powder is then dry blended with an additional 5 weight percent of nano-sized inorganic filler, and the process repeated until the desired level of nano-sized inorganic filler is reached. 20, 25 and even higher loading of the nano-sized inorganic filler is possible using this iterative method.

Another method involves producing a cell cast PMMA to which15 wt %, 20wt % and up to 30 wt % of nano-sized inorganic fill is added, based on the weight of the total weight of PMMA and nano-sized inorganic filler. While the nano-sized inorganic filler may not be well-dispersed into the cell-cast PMMA, it makes little difference, since the cast sheet is then ground into a powder for use in the melt-production process to form the final article. The ground powder is then either melt processed, or used as a master batch to blend with unmodified PMMA, to provide the desired level of nano-sized inorganic filler in the composition.

Alternately, the nano-sized inorganic filler could be blended with a solution or emulsion of the thermoplastic after a polymerization, and the dispersion blend spray dried together to form an intimate blend of nano-sized inorganic filler and polymer powders. A nano-sized inorganic filler dispersion could also be separately fed into a spray dryer with a polymer stream, and the two streams co-spray dried.

In another preferred embodiment, a nano-sized inorganic filler, is added into a molten stream of thermoplastic in the heat processing equipment. An especially preferred embodiment is the addition of nano-sized inorganic filler into a PMMA melt using a side-stuffer, which is a feeder placed downstream of the main feed on a compounding extruder. This downstream feeder allows the nano-sized inorganic filler to be fed directly into the molten thermoplastic stream. It was found that by adding nano-sized inorganic filler directly into a PMMA melt, a homogeneous distribution of the nano-sized inorganic filler was produced at high levels of nano-sized inorganic filler addition of greater than 10 weight percent and even 14 and 15 weight percent nano-sized inorganic filler addition, based on the weight of the thermoplastic. It is contemplated that even higher levels of 15 to 30 weight percent of nano-sized inorganic filler addition can be accomplished in a single pass, using this methodology.

In one preferred embodiment, an inorganic filler is heated prior to addition to the thermoplastic melt stream. This pre-heating of the inorganic filler can be beneficial in the both the direct addition to the melt stream, and especially when added down-stream through a side stuffer. The preheating appears to have less negative impact on the rheology of the molten thermoplastic than the addition of a non-heated inorganic filler. Any heating of the inorganic filler is useful, with heating to near the temperature of the molten thermoplastic being preferred.

In another preferred embodiment, the inorganic filler is densified prior to addition into the molten thermoplastic stream. This is especially useful when the inorganic filler is added in a side stuffer. Since an acrylic thermoplastic has a density of about 1.4 g/cm³, and the density of a typical fumed silica, an inorganic filler, is about 0.02 g/c m³, densification of the inorganic filler provides a means for incorporating the inorganic filler in a more rapid manner and at a higher loading. Densification can occur in any manner known to those in the art, including the use of pressure, and by wetting the inorganic filler. Pressure can be applied by means of a densifying screw feeder, as described in U.S. Pat. Nos. 6,156,285 and 505,874, or a crammer feeder. Densification by the addition of a small amount of liquid to the inorganic filler also facilitates handling. Examples of suitable liquids for densifying the inorganic filler include, but are not limited to, water, methanol, organic solvents, stearyl alcohol, lubricants, methyl methacrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers, styrene and its derivatives, and Alkyl (meth) acrylic acids such as (meth)acrylic acid and acrylic acid. Devolitilization of the liquid may be accomplished during extrusion downstream of the incorporation of the inorganic filler via apparatus such as vacuum vents or devolitilization extruders.

In one embodiment, one or more vinyl monomers, preferably (meth)acrylic monomers, acrylic monomers, and/or styrene monomer and its derivatives, is used as a densifying liquid for compounding the inorganic filler into an acrylic thermoplastic, and preferably PMMA. The vinyl monomer may be combined with a polymerization initiator, preferably an organic peroxide initiator, and mixed with the inorganic filler in order to densify the inorganic filler. Then, the vinyl monomer within the densified mixture may be polymerized prior to and/or during extrusion. Devolitilization of the liquid that is not polymerized may be accomplished during extrusion downstream of its incorporation into the inorganic filler via apparatus such as vacuum vents and devolitilization extruders. The densified mixture after polymerization may be useful because it may have increased bulk density and improved powder flow properties compared to the untreated inorganic filler.

In another embodiment, an inorganic filler, at from 0.1 to 20 wt %, is dispersed into acrylic monomer or a mixture of acrylic monomer plus thermoplastic polymer. To this acrylic monomer dispersion, appropriate initiators and additives are added, as described in US 2014/1256850. This dispersion then polymerizes either in a continuous reactor, in a mold defined by solid sheets (cell cast process), or in a continuous process involving wetting fibers or a fiber mat or net with the monomer/nano-sized inorganic filler dispersion, followed by polymerization in an oven; or a one or two sided mold (cast surfaces, vacuum infusion, resin transfer molding, in mold coating-where a thin layer of acrylic monomer or acrylic monomer plus thermoplastic polymer is applied to a solid surface in a mold and then polymerized—(one example of this type of process is commercially known as Coverform®)—where fiber reinforcement may optionally be utilized. In cases where a mold is utilized, the surface chemistry of either the mold or the nano-sized inorganic filler may be modified to promote increased concentration of the inorganic filler in the vicinity of the surface as compared to the bulk concentration. This allows for improved scratch and/or mar resistance with lower loading levels of the inorganic filler than if surfaces had not been modified.

### Articles

Articles and plaques for testing are formed by heat processing. Useful heat processing methods include, but are not limited to injection molding, extrusion and coextrusion, film extrusion, blow molding, lamination, extrusion lamination, rotomolding, and compression molding. The articles or plaques can be monolithic or multi-layered. Injection molding of these materials utilizing inductively heated surfaces (one example is commercially known as RocTool® as described in U.S. Pat. Nos. 7,419,631 BB, 7,679,036 BB, EP2694277 B1) on one or both surfaces of the mold may generate a surface morphology that may further enhance the scratch and/or mar resistance of molded articles.

Other additives, and the optional pigments and dyes can be dry blended into the composition prior to heat processing into the final article. In the case of some additives, such as the pigment or dye, a masterbatch containing a concentrate could be used.

Multi-layer articles are also contemplated by the invention. The composition of the invention is used on one or more outer side(s) exposed to the environment over a substrate. The multi-layer article could be two layers, or multiple layers, that could include adhesive and/or tie layers. Substrates contemplated for use in the multi-layer article include, but are not limited to thermoplastics, thermoset polymers, wood, metal, masonry, wovens, non-wovens.

The multi-layer articles can be formed by means known in the art, including, but not limited to: coextrusion, co-injection molding, two shot injection molding, insert molding, extrusion lamination, compression molding, lamination.

In one embodiment, the multi-layer article has an outer layer and an inner layer, where the outer layer has a thickness of from 0.1 to 10 mm, and said inner layer has a thickness of from 0.1 to 250 mm. At least one of the layers may contain from 0.05 to 25 weight percent and preferably 0.1 to 20 weight percent, more preferably 0.7 to 5 weight percent, based on the weight of the thermoplastic of other additives, including but not limited to: dyes, pigment—including neutral density pigments, metallic flake, matting agent, and cross-linked polymers having a granite look.

In one embodiment the article is a cover that is molded directly over a light source, or used to cover a light source.

### Properties

The composition of the invention, when heat processed to form an article or test sample, provides a unique combination of gloss and mar resistance properties, that are useful in several applications.

The articles have a high gloss. By high gloss is meant that the 60° gloss measurement is greater than 20, preferably greater than 30, more preferably greater than 50, more preferably greater than 60, and most preferably greater than 70. There is very little loss in gloss for an article made from the composition of the invention, when compared to an article made from the same composition, but with no nano-sized inorganic filler. For example, an injected molded plaque formed from a composition containing 20 wt % of nano-silica has a gloss that is within 30%, preferably within 20%, more preferably within 10%, and most preferably within 5% of an injection molded plaque of similar composition but without the nano-sized inorganic filler, as measured by a BYK gloss meter.

Articles formed from the composition of the invention also have a high mar resistance as evidenced by gloss retention upon mar. The gloss of an article formed from the composition of the invention not only as a high initial gloss, but the high gloss is maintained with time and wear. For example, a plaque formed by injection molding has superior mar resistance (measured as either an increase in 60° gloss or a decrease in 60° gloss of <20 units, and preferably 15 units, more preferably 10 units, and most preferably 5 units, after 250 cycles in a Crock Meter Mar (SDL-Atlas model M238BB) using 3M polishing paper (part #3M281Q)) test using a 2 micron aluminum oxide cloth abrading material, as compared to a composition without the nano-sized inorganic filler which would experience a 60° gloss loss of >20 units in a similar test.

Articles formed from the composition also have excellent color. For example, an injected molded plaque formed from the composition of the invention has a Delta E Color value that is <20 units, preferably within 10 units, more preferably within 5 units, and most preferably within 2.5 units as compared to the color an injection molded plaque of similar composition but without the nano-sized inorganic filler measured by CIE L*a*b* on X-Rite Color 17 spectrophotometer.

Nanographite, whether used alone in the thermoplastic, or used in combination with silica or other nano-sized inorganic filler, was found to have a dramatic effect on improving the scratch resistance of a heat-formed plaques. The scratch resistance was improved by over 12 units of force compared to an unmodified thermoplastic, with no visible scratching.

For example, as compared to an injection molded plaque of similar composition containing no nanocarbon, a nanocarbon-modified sample was found to provide a 10%, preferably 20%, more preferably 30%, more preferably 40%,and most preferably 50% decrease in scratch width when tested in a 5 finger test with load of >3N of force and still maintains a superior mar resistance. The mar resistance is demonstrated by maintaining gloss after mar-measured as either an increase in 60° gloss or a decrease in 60° gloss of <20 units, preferably <15, more preferably <10, and most preferably <5 after 250 cycles in a Crock Meter Mar test using a 2 micron aluminum oxide cloth abrading material, as compared to a similar composition without the nano-sized inorganic filler which would experience a 60° gloss loss of >20 units in a similar test.

Test plaques formed from the composition of the invention that included 0.01 to 5 weight percent of nanographite and 1 to 25 weight percent of silica, a synergy was found, providing both superior scratch resistance and mar resistance.

Nano-zinc oxide when used in the thermoplastic was found to drastically increase the scratch resistance of the material. For example, when nano-sized zinc oxide is melt compounded into PMMA at levels of 5-15% with an appropriate pigment, the depth of scratches is considerably lower as compared to the same composition without nano-sized zinc oxide.

### Uses

The composition of the invention is useful in forming high gloss, scratch and mar resistant articles for many applications, including but not limited to building and construction (such as decking, railings, siding, fencing, and window and door profiles); automotive applications (such as exterior trim, interiors, mirror housings, fenders); electronics (such as ear buds, cell phone cases, computer housings); custom sheet applications especially as a capstock; and outdoor equipment (such as snow mobiles, recreational vehicles, jet skis).

One preferred use of a single layer or multi-layer article of the invention is for use as a cover for a light source. The UV resistance, scratch resistance, and mar resistance imparted by articles made of the composition of the invention makes them extremely useful in covering light sources exposed to the environment. Such lighting covers include, but are not limited to, covers for lighted signage and displays, covers for street lights, and covers for automobile and other transportation exterior lighting, including headlights, tail lights and decorative lighting. The lighting of the article can be located directly behind the article, as an edge-lit light source, or for covering an indirect light source.

### EXAMPLES

### Example 1

Pulverized polymethyl methacrylate resin, PLEXIGLAS V-825 from Arkema, was bag mixed with a nano-silica at a ratio of 95% methacrylic resin to 5% silica by weight. The mixture was fed into the feed throat of an 18 mm twin screw extruder using typical PMMA extrusion conditions. The extruded strands were then pelletized and collected. The 5 wt % silica is about the maximum level that can be fed into the 18 mm extruder under the chosen conditions. If higher levels are desired, the process is repeated one or more times, by finely granulating the pellets and bag mixing them with an additional 5% of silica. This new mixture is then extruded, increasing the silica level to about 10%. The process can be repeated, increasing the level of silica by about 5% with each pass. After the desired level of silica is prepared, an additional pass through the extruder is used to add the appropriate level of high-gloss, weatherable color concentrate. The final blend is the injection molded into parts or test specimens, using standard injection molding techniques.

Test specimens prepared by the injection molding process are tested for gloss using a Byk-Gardner micro-gloss meter. The gloss numbers observed for samples containing about 20 wt % of silica are consistently >80 when measured at 60°. The difference between samples containing 0% silica and 20 wt % silica is less than 3 gloss units.

Mar testing was also be conducted on the samples. Samples were tested using a Crockmeter (SDL-Atlas model M238BB) using 3M polishing paper (part #3M281Q). It was observed that samples with 15 to 20 weight percent silica are essentially unchanged in appearance when tested for 200 rubbing cycles, while control samples containing no silica show extensive marring and surface roughening.

It was also observed that the addition of 20 weight percent of nano-sized silica has only a minor effect on the MFI of the resin. In one experiment for a black PMMA containing no silica, the MFI was measured at 3.7. A sample of the same black PMMA containing 20 wt % of silica had an MFI of only 3.5. This means that the high silica PMMA will process in a similar manner to the unmodified PMMA. However, PMMA-containing unmodified silica of similar particle size results in a significant increase of process viscosity (MFI=1). Further, unmodified silica significantly reduces the MFI by 60-70% at a loading of 20% silica. In contrast, silica with a non-polar surface treatment showed only about a 5% reduction in MFI. A high MFI is a critical property when using an over-molding process.

### Example 2

The acrylic resin chosen for the experiment was PLEXIGLAS V825-100, pigmented with 3% 99110 opaque black colorant. The silica used was CAB-O-SIL® TS610. Equipment used was a 30 mm co-rotating twin screw compounder with screws design for short glass fibers. CAB-O-SIL® TS610 was successfully added to the V825-99110 melt using a side feeding system, “side stuffer”, designed for inorganic polymer additives. Loading levels obtained during this experiment were 10, 12 and 14% by weight. It may be possible to load at even high levels however those levels were outside the scope of this experiment.

### Example 2a

Acrylic resin, PLEXIGLAS V-825-100 from Arkema Inc., was bag mixed with a Zinc Oxide (ZnO) powder at a ratio of 95% methacrylic resin to 5% ZnO by weight, 90% methacrylic resin to 10% ZnO by weight, and 85% methacrylic resin to 15% ZnO by weight, and 100% methacrylic resin to 0% ZnO by weight, each with additional appropriate level of weatherable color concentrate. In each case, the mixture was fed into the feed throat of a 27 mm twin screw extruder using typical PMMA extrusion conditions. The extruded strands were then pelletized and collected. The final blend is the injection molded into parts or test specimens, using standard injection molding techniques.

Test specimens prepared by the injection molding process are tested for scratch resistance with a Taber scratch Tester (Diamond tip 90 μm), operating mode MOD-SDA-012. The scratch tip loads were varied from 0.5 to 1.5 N force. Scratch depth is evaluated with a non-contact optical profilometer. The scratch depth of each material is listed in Table 1. Reduced scratch depth is seen for samples with ZnO, compared to V825 without ZnO.

TABLE 1

| Sample Composition | | | | | | |
|---|---|---|---|---|---|---|
| Plexiglas ® | ZnO | Scratch Depth (μm) | | | | |
| V-825-100 (wt %) | (wt %) | 0.5N | 0.7N | 1N | 1.2N | 1.5N |
| 100 | 0 | ND | ND | 0.398 | 0.750 | 1.127 |
| 95 | 5 | ND | ND | ND | 0.520 | 0.837 |
| 90 | 10 | ND | ND | ND | ND | 0.697 |
| 85 | 15 | ND | ND | ND | ND | ND |

ND = Scratch depth too small to be determined

### Example 3

Injection molding was made to prepare a multilayer substrate. Trinseo Magnum 3904 Smooth Natural was injection molded into 2″ by 3″ plaques (varying in thickness from 1.6 mm-2.3 mm) on a KraussMafei injection molder. These plaques were insert molded into thicker 2″ by 3″ cavities. The PLEXIGLAS V825-100 with 15% CAB-O-SIL® TS-530 (compounded as described in example 2) was then injection molded over the ABS plaque at a thickness of 1.6 to 0.9 mm, giving a total thickness of 3.2 mm. As a control, non-modified Plexiglas V825 was also molded over the ABS plaques. Mar resistance testing was carried out as described in example 1 on the plaques with 1.6 mm substrate and 1.6 mm cap thickness. Plaques with the cap modified with silica showed improved gloss retention and less evidence of mar.

### Example 4

2-12 g of Cab-O-Sil HS-5 are dispersed in 200 g MMA with a lab shaker for 30 minutes at room temperature. Once dispersed, initiators and additives are added. The mixture is poured into a glass mold that consists of two tempered glass plates and a PVC spacer. The mold is immersed and polymerized in the water bath at 60° C. for 4 hours. A ¼″ thick translucent sheet is obtained with smooth and glossy surface. Nanosilica distribution appeared to be uniform throughout the sheet after polymerization. For comparison, 200 g MMA was mixed with initiators and additives. The mixture is poured into a glass mold that consists of two tempered glass plates and a PVC spacer. The mold is immersed and polymerized in the water bath at 60° C. for 4 hours. A ¼″ thick sheet is obtained with smooth and glossy surface.

Scratch testing with a five-finger scratch tester at 10N, 15N, and 20N forces shows no visible scratches on any samples containing silica. The 20N scratch on the PMMA sheet without silica was visible. While not being bound by any particular theory, it is believed that the higher molecular weight of cast sheet along with silica being distributed primarily on the surfaces contributed to the excellent scratch resistance.

### Example 5

5% by weight Nano-silica (CAB-O-SIL® M-5) and black pigment were compounded into poly(methyl methacrylate-co-methacrylic acid) according to a similar procedure as described in example 1 using a 27 mm twin screw extruder. Test specimens (with and without nanosilica) prepared by the injection molding process are tested for gloss using a BYK-Gardner micro-gloss meter. Mar testing was performed through the procedure described in example 1 with 10 cycles of marring. Plaques with 5% by weight nanosilica showed either an increase in gloss (measured at 20° or 60°) or a decrease of <1% after mar testing. Plaques without the nanosilica showed a decrease in gloss (due to marring) of >10%.

Table 2 shows that the mar resistance of poly(methacrylate-co-methacrylic acid)may be improved with addition of 5 wt % unmodified silica (Cabot CAB-O-SIL® M-5). The mar resistance is quantified as the ability to maintain gloss after a mar test. For example, neat poly(methacrylate-co-methacrylic acid) loses gloss after marring, while the poly(methacrylate-co-methacrylic acid) with silica maintains the gloss (see Table 2).

TABLE 2

| | | | AS | | AFTER | |
|---|---|---|---|---|---|---|
| | | | MOLDED | | MARRING¹ | |
| | | Additive | Gloss | Gloss | Gloss | Gloss |
| Sample | Resin | (wt %) | 20° | 60° | 20° | 60° |
| A | poly(meth- | none | 77.9 | 86.2 | 58.3 | 77 |
| | acrylate-co- | | | | | |
| | methacrylic | | | | | |
| | acid) | | | | | |
| B | poly(meth- | Silica M5 | 43.2 | 73.7 | 44.5 | 73.5 |
| | acrylate-co- | (5) | | | | |
| | methacrylic | | | | | |
| | acid) | | | | | |

### Example 6

Methyl Methacrylate (MMA) liquid was combined with CAB-O-SIL® TS-622 fumed silica at weight ratios described in Table 3 and mixed, producing a material with increased bulk density compared to CAB-O-SIL® TS-622. The MMA/Fumed silica blend would be blended with Plexiglas® V825-99110 melt using a side feeding system, “side stuffer”, designed for inorganic polymer additives. It would be possible to load greater than or equal to 30% by weight of the MMA/fumed silica blend by weight. The MMA would be removed from the extruder via one or more vacuum ports and/or one or more devolatilization extrusion systems, such that the composition of the extruded material at the extruder die is 15 wt % CAB-O-SIL® TS-622 fumed silica in 85 wt % V825-99110.

TABLE 3

| | | | | | | CAB-O- |
|---|---|---|---|---|---|---|
| | Sample | Sample | Sample | Sample | Sample | SIL ® |
| | 1 | 2 | 3 | 4 | 5 | TS-622 |
| CAB-O- | 1.5 | 1.5 | 1.5 | 1.5 | 1.5 | 1.5 |
| SIL ® | | | | | | |
| TS-622 (g) | | | | | | |
| Methyl | 1.5 | 2.3 | 3 | 3.8 | 4.5 | 0 |
| Methacrylate | | | | | | |
| (MMA) (g) | | | | | | |
| Bulk density | 218 | 368 | 502 | 592 | 792 | <64 |
| after | | | | | | |
| mixing (g/L) | | | | | | |

### Example 7

A liquid mixture of 98 wt % Methyl Methacrylate (MMA) and 2 wt % Perkadox® 16 was combined with CAB-O-SIL® TS-622 fumed silica at weight ratios described in Table 4 and mixed, producing materials with increased bulk density compared to CAB-O-SIIL® TS-622. The mixtures were placed in an 80° C. oven for 24 hours. The resulting material is a powder with increased bulk density and improved powder flow characteristics compared to CAB-O-SIL® TS-622. The resulting material, would be blended with Plexiglas® V825-99110 melt using a side feeding system, “side stuffer”, designed for inorganic polymer additives. It would be possible to load greater than or equal to 30% by weight of the MMA/fumed silica blend by weight, such that the composition of the extruded material at the extruder die is 15 wt % CAB-O-SIL® TS-622 fumed silica in 85 wt % acrylic resin. The unreacted MMA, if any, would be removed from the extruder via one or more vacuum ports and/or one or more devolatilization extrusion systems.

TABLE 4

| | Sample | Sample | Sample | Sample | Sample | Cabot ® |
|---|---|---|---|---|---|---|
| | 6 | 7 | 8 | 9 | 10 | TS-622 |
| Silica Mass (g) | 1.5 | 1.5 | 1.5 | 1.5 | 1.5 | 1.5 |
| Methyl Meth- | 1.5 | 2.3 | 3 | 3.8 | 4.5 | 0 |
| acrylate/P16 | | | | | | |
| (98/2 wt %) (g) | | | | | | |
| Bulk density | 218 | 394 | 594 | 641 | 871 | <64 |
| (g/L)* | | | | | | |

1. A composition comprising
a) one or more thermoplastics
b) greater than 1 weight percent of one or more nano-sized inorganic filler, based on the weight of the thermoplastic, and having a number average particle size of less than 500 nm,
c) from 0.05 to 20 weight percent of dye and/or pigment, based on the weight of the thermoplastic.

2. The composition of claim 1, wherein said dye or pigment comprises a carbonaceous material.

3. The composition of claim 2, wherein said carbonaceous material is a nano carbon, having a number average particle size of less than 500 nm.

4. The composition of claim 2, wherein said carbonaceous material is selected from the group consisting of nano-graphite, thermally reduced graphite oxide, graphite flakes, expanded graphite, graphite nano-platelets, graphene, single-walled carbon nanotubes, multi-walleyed carbon nanotubes, multi-layered graphenes.

5. The composition of claim 1, wherein said nano-sized inorganic filler is a silica compound.

6. The composition of claim 5, wherein said silica compound is selected from the group consisting of fumed silica, precipitated silica, silica fume, or silicas produced by sol-gel processes.

7. The composition of claim 1, wherein said thermoplastic is selected from the group consisting of acrylic polymers, styrenic polymers, polystyrene, acrylonitrile-butadiene-styrene (ABS) copolymers, acrylonitrile-styrene-acrylate (ASA) copolymers, styrene acrylonitrile (SAN) copolymers, polyolefins, polyvinyl chloride (PVC), polycarbonate (PC), polyurethane (PU), Polyamides (PA), Polypropylene oxide (PPO), Polyesters, thermoplastic fluoropolymers and mixtures thereof.

8. The composition of claim 1, wherein said nano-sized inorganic filler is zinc oxide.

9. The composition of claim 7, wherein said thermoplastic is an acrylic polymer.

10. The composition of claim 9, wherein said acrylic polymer is an acrylic copolymer containing ethoxylated acrylic monomers, vinyl alcohol, acrylamide, (meth)acrylic acid monomer units.

11. The composition of claim 9, wherein said acrylic polymer has a Melt Flow Rate of >3 when measured by ASTM D1238 with 230° C., 3.8 kg.

12. The composition of claim 1 wherein a plaque formed by injection molding has superior mar resistance as measured by an increase in 60° gloss or a decrease in 60° gloss of <20 units, after 250 cycles in a Crock Meter Mar test using a 2 micron aluminum oxide cloth abrading material, as compared to a composition without the nano-sized inorganic filler which would experience a 60° gloss loss of >20 units in a similar test.

13. The composition of claim 1, where an injected molded plaque formed from said composition has a gloss that is within 30%, of an injection molded plaque of similar composition but without the nano-sized inorganic filler measured by BYK gloss meter.

14. The composition of claim 1, where an injected molded plaque formed from said composition has a Delta E Color Value that is <20 units, as compared to the color an injection molded plaque of similar composition but without the nano-sized inorganic filler measured by CIE L*a*b* on X-Rite Color I7 spectrophotometer.

15. The composition of claim 2, wherein said composition comprises 0.01 to 5 weight percent of nanographite and 1 to 25 weight percent of silica, wherein an injection molded plaque heat formed from said composition has superior scratch resistance as compared to an injection molded plaque of similar composition but without the nanocarbon as measured by at least a 10%, decrease in scratch width when tested in a 4 finger test with a load of greater than 3N of force and a superior mar resistance, as measured as either an increase in 60° gloss or a decrease in 60° gloss of <20 units, after 250 cycles in a Crock Meter Mar test using a 2 micron aluminum oxide cloth abrading material, as compared to a similar composition without the nano-sized inorganic filler which would experience a 60° gloss loss of >20 units in a similar test.

16. The composition according to claim 1 wherein said nano-sized inorganic filler comprises a surface treatment, and wherein said surface-modified nano-sized inorganic filler is selected such that a PMMA plaque formed using 20 weight percent loading surface-modified nano-sized inorganic filler has a MFI decrease of less than 30%, compared to a similar plaques comprising 20 weight percent of an un-modified nano-sized inorganic filler.

17. The composition of claim 1, wherein said composition comprises 1 to 15 weight percent of nano-sized zinc oxide, wherein an injection molded plaque heat formed from said composition has superior scratch resistance as compared to an injection molded plaque of similar composition but without the zinc oxide as measured by at least a 10%, decrease in scratch depth when tested in a Taber scratch test with load of 0.5 to 1.5 N of force.

18. A composition comprising:
a) an acrylic polymer having a weight average molecular weight of greater than 500,000;
b) greater than 1 weight percent, of one or more nano-sized inorganic filler, based on the weight of the thermoplastic, and having a number average particle size of less than 500 nm.

19. The composition of claim 18, wherein said composition further comprises from 0.05 to 20 weight percent of dye and/or pigment, based on the weight of the acrylic polymer.

20. The composition of claim 18, wherein said composition is formed by a cell cast process.

21. A process for increasing scratch or mar resistance without loss of gloss in a melt process thermoplastic article comprising the steps of adding one or more nano-sized inorganic filler(s) to a thermoplastic via melt compounding, wherein said nano-sized inorganic filler is added at levels of greater than 0.1 weight percent.

22. The process of claim 21, wherein said inorganic filler is added directly to the thermoplastic melt via one or more side stuffers placed downstream on the extrusion barrel from the main feeder where thermoplastic resin is added.

23. The process of claim 22 wherein a densifying screw feeder or crammer feeder is incorporated into at least one side stuffer.

24. The process of claim 21 wherein said inorganic filler is preheated prior to being added to the thermoplastic in the melt compounding step.

25. The process of claim 21 wherein a liquid is added to the inorganic additive prior to addition to the molten thermoplastic stream, and is removed downstream in the extruder by devolitilization.

26. The process of claim 21 where a liquid blend is added to the inorganic additive prior to addition to the molten thermoplastic stream, said liquid blend comprising a) a vinyl monomer selected from the group consisting of (meth)acrylic monomer, acrylic monomer, styrene, and methylmethacrylate monomer, and b) a polymerization initiator, and wherein said vinyl monomer is polymerized prior to, during, or following extrusion.

27. The process of claim 21, comprising multiple iterations of pulverization and melt extrusion, to achieve very high loadings of nano-sized inorganic filler by adding up to 5 weight percent or more inorganic filler on each pass.

28. A process for forming a homogeneous blend composition of a thermoplastic and a nano-sized inorganic filler, comprising the step of combining a nano-sized inorganic filler and one or more initiators; with one or more (meth)acrylic monomer(s), or in a mixture of (meth)acrylic monomer(s) and thermoplastic polymer, followed by polymerization of the (meth)acrylic monomer.

29. The process of claim 28 wherein said (meth)acrylic monomer/nano-sized inorganic filler mixture said polymerization occurs in a continuous mass reactor, followed by devolatization and extrusion.

30. The process of claim 28 wherein said (meth)acrylic monomer(s)/nano-sized inorganic filler dispersion further comprises optional additives and wet-out fibers or fillers, is polymerized inside of a one or two sided mold, with suitable.

31. A monolithic or multi-layer structure, wherein the layer in contact with the environment, comprises a thermoplastic matrix having dispersed therein greater than 1 weight percent, of nano-sized inorganic filler, based on the weight of the thermoplastic, and wherein said nano-size inorganic filler has a number average particle size of less than 500 nm.

32. The structure of claim 31, wherein said structure is a multilayer structure formed by coextrusion, co-injection molding, two shot injection molding, injection molding utilizing inductive heated surface(s), insert molding, extrusion lamination, or compression molding.

33. The structure of claim 31, comprising an outer layer exposed to the environment and an inner substrate layer, wherein the outer layer has a thickness of from 0.1 to 10 mm, and said inner layer has a thickness of from 0.1 to 250 mm.

34. The structure of claim 31, wherein at least one layer further comprises from 0.05 to 25 weight percent of additives selected from the group consisting of dyes, pigment metallic flakes, matting agents and granite-look cross-linked polymer particles based on the weight of the thermoplastic.

35. The structure of claim 31, wherein said structure is a cover for a light source.
